(19) United States
(12) Patent Application Publication
(10) Pub. No.: US 2026/0338976 A1
(43) Pub. Date: Oct. 29, 2026

(54) Correction of Dynamic Artifacts in Photon Counting Imagers

(71) Applicant: Varex Imaging Corporation, Salt Lake City, UT (US)

(72) Inventors: Kevin Holt, Chicago, IL (US); Rui Guo, Salt Lake City, UT (US); Henrik Lohman, Salt Lake City, UT (US); Mattias Urech, Nacka (SE); Alex Stewart, San Francisco, CA (US)

(21) Appl. No.: 19/416,231

(22) Filed: Dec. 11, 2025

Related U.S. Application Data
(60) Provisional application No. 63/794,261, filed on Apr. 24, 2025.

(51) Int. Cl. G01T 7/00; G06T 5/70

(52) U.S. Cl. CPC G01T 7/005; G06T 5/70; G06T 2207/10116

(57) ABSTRACT

Embodiments are provided to reduce or remove ‘vein’ or similar artifacts from photon-counting image sensors. The embodiments herein include identifying, from a set of calibration images, a set of calibration basis images that represent the structure of variation exhibited by the vein artifacts in an image sensor in the logarithm or other nonlinear function of the image space. Then, a target image can be corrected to remove vein artifacts by projecting a logarithm or other nonlinear function of a block of images (that includes the target image) into the space of the calibration basis images. This projection is then used to predict the structure of the vein artifacts within the target image so that they can be, in the logarithm or other nonlinear function of the image space, subtracted from the target image.

### CROSS-REFERENCE TO RELATED APPLICATIONS

This application claims priority to U.S. Provisional Patent Application No. 63/794,261, filed 24 Apr. 2025, the entire disclosure of which is hereby incorporated by reference.

### BACKGROUND

A variety of different physical processes can cause the introduction of ‘noise’ or other unwanted contents into the image information generated by an image sensor. Such processes can be related to the physical construction and operation of the image sensor, e.g., thermal noise could be introduced that is related to the temperature of an image sensing device. The properties of certain noise sources can allow some or all of the noise content in an image to be removed, e.g., by taking a mean across a sequence of images to remove noise sources that are correlated and relatively stationary over time. However, certain noise sources may exhibit more complex structure (e.g., a spatial pattern that can vary across multiple dimensions within the space of possible images) that varies quickly and/or in a difficult-to-model manner dependent upon multiple physical variables that, themselves, can be difficult to detect and/or model (e.g., local sensor or pixel temperature, cumulative or otherwise filtered image intensity or number of collected photons, local electrical field or applied bias voltage, polarization, charge trapping, and/or some other factors or mechanisms). To reduce or remove such noise sources, more complex methods may be needed.

### SUMMARY

According to the disclosure, a method is provided that includes: (i) obtaining a set of nonlinear calibration basis images (e.g., logarithmic calibration basis images, or calibration basis images projected into some other nonlinear space that linearizes them with respect to artifacts as described herein) for an X-ray image sensor; (ii) obtaining a block image by (a) using the X-ray image sensor to generate a set of production images and (b) determining a nonlinear function of a pixelwise average of a subset of the set of production images; (iii) projecting a first subset of pixels of the block image onto the set of calibration basis images to determine, for a target image of the set of production images, a first weighted combination of the calibration basis images; and (iv) correcting a second subset of pixels of the target image by subtracting therefrom, in the nonlinear space of the nonlinear function, the set of calibration basis images combined according to the first weighted combination, wherein the second subset of pixels is a superset of the first subset of pixels.

According to another embodiment, a non-transitory computer readable medium is provided having stored thereon program instructions executable by at least one processor to cause the at least one processor to perform the method described above.

According to yet another embodiment, a system is provided that includes: (i) a controller comprising one or more processor, and (ii) a non-transitory computer readable medium having stored thereon program instructions executable by the controller to cause the controller to perform the method described above.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 depicts images relating to aspects of an example method, according to example embodiments.

FIG. 2 depicts aspects of an example method, according to example embodiments.

FIG. 3 depicts aspects of an example method, according to example embodiments.

FIG. 4 depicts experimental results.

FIG. 5 depicts aspects of a system, according to example embodiments.

FIG. 6 depicts a flowchart of an example method.

### DETAILED DESCRIPTION

### I. Overview

A variety of types of image sensors can be operated in a variety of ways to generate images of a variety of subjects. For example, X-rays or other high-energy photons can be directed through a body part of a patient or other object, and then the spatial pattern of intensity of the photons that are transmitted through the object (rather than being absorbed, scattered, or otherwise prevented from being imaged) can be detected by an image sensor to generate an image of the pattern of absorption of the photons by the object. Such an image sensor could be a direct conversion image detector that detects the photons directly or could include a scintillator or other transducer element to detect photons or other energy generated by the interaction of the photons with the transducer element. For example, the sensor could be operated to detect, at each pixel of the detector, individual received photons (e.g., as a direct conversion photon-counting detector capable of detecting the timing of reception and/or energy of individual photons and/or to detect the exact number of photons detected over time) and/or a measure of the overall energy of received photons across an exposure time (e.g. as an energy-integrating scintillator-based detector).

Different image sensor types, and methods of operating such sensors to generate images therefrom (e.g., exposure times, bias voltages, readout circuitry operation, blanking periods) can result in the images generated therefrom exhibiting different types of noise and/or artifacts. It is desirable to attempt to reduce or remove such artifacts, if possible, from the image data, in order to arrive at images of target objects that more accurately represent the objects as they are and including no, or reduced, non-object artifacts, noise, or other unwanted image contents. The ability to correct for such unwanted contents, and the methods by which such removal can be accomplished, may be related to the physical mechanisms underlying the generation of the contents. Some physical mechanisms affect each pixel largely independently. For example, thermal noise could cause the addition of a random signal to the outputs of an image sensor, and could be reduced by actively cooling an image sensor, by applying software-based denoising algorithms, and/or by some other methods. In another example, where an image sensor includes defects (e.g., pixels whose outputs exhibit no, minimal, or unreliable relationship to the magnitude or other properties of image photons impinging thereon) and/or areas of the detector that are not irradiated by image light (e.g. pixels in the shadow of a collimator or other scanner structure, whose outputs thus exhibit no or minimal relationship to the object being imaged, regardless of whether or not there is a defect). Such pixels can be broadly considered as “bad” pixels, which can be detected and their values removed from the output image and/or not used for intermediate image processing steps (e.g., setting the bad pixel values to zero or some other default value, inpainting the value of such bad pixels from the values of nearby non-‘bad’ pixels of an image sensor, and/or giving them zero weight in correction algorithms). For photon-counting detectors, pulse pile-up correction can be applied to account for the coincidental reception of multiple photons at the ‘same time’ or otherwise sufficiently coincidentally that readout circuitry of the image sensor is not able, or less able, to distinguish the two (or more) coincidentally received photons. For photon-counting detectors, “Multi-Gain” correction can account for sensitivity variations that depend on time, temperature, high-voltage bias refresh, or similar factors. Lag correction can correct for electronics response time, charge trapping, and afterglow (e.g. for scintillator detectors). Numerous other corrections may also be desirable, e.g. to attempt to correct for source flux variations, dark current drift, long term stability, scatter, or a myriad of other effects. Many such corrections can, in many applications, be combined, e.g. by serially cascading them.

Some artifact mechanisms have effects that are dependent or otherwise inter-related over space across a detector (e.g., across multiple pixels of a detector). The effects of such artifact mechanisms can be, for example, global (over the entire detector), constrained to a local neighborhood, or tile-wide (globally within a single tile, but not extending outside the single tile). A “tile” is a module of pixels (e.g., an array of pixels formed form the same contiguous piece of semiconductor or other detector material). A multi-tile detector is comprised of an arrangement of such tiles, for example, a flat detector made of a 2D array of flat 2D tiles, a flat detector made of a 2D array of sub-modules that each contain a 1D array of 2D tiles, an (approximately) arc-shaped detector made of a cylindrical-arc arrangement of flat 1D or 2D tiles, an (approximately) arc-shaped detector made of a cylindrical-arc arrangement of flat sub-modules that each contain a flat array of flat 1D or 2D tiles, an arc detector formed by an arrangement of curved tiles, a flat panel super-detector made by putting several flat panel detectors side by side, and so on. The methods described herein can also be used in an “untiled” detector (e.g. a single monolithic flat panel detector). Many types of artifacts are per-tile, or tile-specific, in nature.

Photon-counting image detectors composed of cadmium telluride or other photon-detecting materials, when used to image incoming X-ray or other photons, can exhibit a variety of tile-specific artifacts induced from tile-specific phenomenon like temperature drift, high voltage gradients, polarization, charge trapping, manufacturing defects, scatter, or object-dependent spectral effects. Tile-specific artifacts can include, for example ‘vein’-like artifacts. Such vein-like artifacts can be induced by changes in the effective pixel boundaries (as defined electrically, not mechanically) over time (so that photons arriving near the mechanical pixel boundary are diverted from one pixel to another, depending on where the electrical pixel boundary has moved over time). Tile-specific artifacts can also include low-frequency shading, for example by all the per-pixel energy thresholds (e.g., as used in pulse-height discrimination) changing in energy over time in a similar manner.

Some physical effects may be additive in nature with respect to their effect on the pixel signal, for example electronic noise or dark current drift. Such additive effects can generally be modeled as a corrupting signal that has been added to the ‘true’ signal. Some physical effects may be multiplicative in nature with respect to their effect on the pixel signal. For example, when the effective stopping area of a pixel changes (which cause vein artifacts), when an energy threshold shifts (in pulse-height discrimination), when source flux changes, or when the spectrum incident on the detector changes. The flux and spectral variation observed in X-ray imaging systems are commonly caused by motions of X-ray sources relative to the detector, and other components in the X-ray imaging system, specifically the “bowtie” source filter commonly used in CT systems and anti-scatter grids (both moving and stationary). Anti-scatter (also referred to as “Bucky”) grids are widely used in clinical radiology and industrial radiography, both for flat panel imaging and for CT scanners. Anti-scatter grids can cause artifacts such as Moiré patterns and gridline shadows. The image variations due to anti-scatter grids are observed as combinations of a limited space spanned by a few specific multiplicative (thus non-linear) patterns of intensity variation in the image (often with poorly predictable magnitude). This makes the methods described herein well suited to anti-scatter grid artifact correction both for flat panel X-ray imaging and for clinical CT, where these techniques have the further advantage of speed of correction used in clinical settings. The bowtie filter also affects the intensity and spectrum of the source radiation reaching the detector (the effect is non-linear (according to the Beer-Lambert Law) and spectrally dependent (according to Moseley's Law)). Small motions of X-ray sources cause larger shifts in the radiation field at the detector due to geometric magnification between the bowtie and the detector. The patterns of variation resulting from small relative motions of the source and bowtie can be extracted and removed using the techniques described herein. These can generally be modeled as a corrupting signal that has been multiplied with the ‘true’ signal. Some physical mechanisms are nonlinear and neither additive or multiplicative, or are a mix of additive, multiplicative, and/or nonlinear effects. Regardless of the particular mechanism leading to such image artifacts, the result is that images generated with cadmium telluride (CdTe) or other direct-conversion photon-counting image sensors, or amorphous silicon or other scintillating detectors, can exhibit artifacts that can vary significantly over an imaging session based on sensor temperature (e.g., per-tile temperature, for multi-tile image sensors) or the temperature gradient within a tile, cumulative or otherwise time-dependent charge accumulation or polarization, voltage drift, or other factors that are difficult to predict, model, and/or to directly measure. Additionally, the relationship between such factors and the pattern of the resulting artifacts can also be difficult to model and/or predict. Thus, naively generating a single ‘artifact image’ at calibration time for such an image sensor may not allow a significant amount of such artifacts to be removed from scan images at scan time, as the actual pattern and magnitude of the artifacts in the image may differ significantly from the pattern of artifacts at the time of the calibration. For example, vein artifacts can come and go or otherwise vary over time but may not be well predicted by any particular hardware measurement(s). Further, effects that are multiplicative or nonlinear, rather than simply additive, can further add to the difficulty in using simple calibration artifact images to correct scan-time images.

The embodiments described herein reflect a variety of improved methods for correcting such vein artifacts in images generated using CdTe, other types of photon-counting image sensors, or other applicable types of image sensor. To reflect the multiplicative aspects of multiplicative effects such as vein artifacts, the embodiments described herein perform various image processing tasks in a logarithmic or other nonlinear image space that is linearizing with respect to the artifact of interest (e.g., a nonlinear space specified by a polynomial or other nonlinear function used to project input ‘linear’ images into the nonlinear space). The nonlinear function could be a natural log or other-base logarithm of the pixel values, or it could be a quasi-logarithm that is log-like for high signal values but apodized or otherwise modified to improve behavior for negative or near-zero signal values. The embodiments herein may, in some examples, describe various embodiments with reference to the use of the logarithm to correct multiplicative effects. However, in such examples one could also use the methods described herein to correct additive effects by using an alternative nonlinearity or, in some examples, by removing the logarithm step entirely. In some examples, one could address a mix of additive and multiplicative effects by including both logged and unlogged versions of the pixel values. Additionally or alternatively, one could address other nonlinear effects by including other nonlinear data transforms in addition to or instead of logged and/or unlogged data. The logarithm of pixel values can be used to generate a logarithm (or other nonlinear function) of the image of the vein or other artifact(s) in a given target image, which is then subtracted from the target image in log (or other nonlinear) image space. To reflect the complex, multi-dimensional nature in which the pattern of artifacts may vary (e.g., with respect to temperature, time, accumulated/dissipated charge), a set of logarithmic (or other nonlinear) calibration basis images, each representing a different pattern (in the logarithm (or other nonlinear function) of the image space) with respect to which the artifacts were observed to vary during a calibration procedure, are used to determine, for a given target image, a logarithmic (or other nonlinear) artifact image as a weighted sum of the logarithmic (or other nonlinear) calibration basis images. The use of such a set of calibration basis images, rather than a single calibration image, allows the more complex, multi-dimensional behavior of vein or other artifacts as described herein to be more accurately modeled and compensated for.

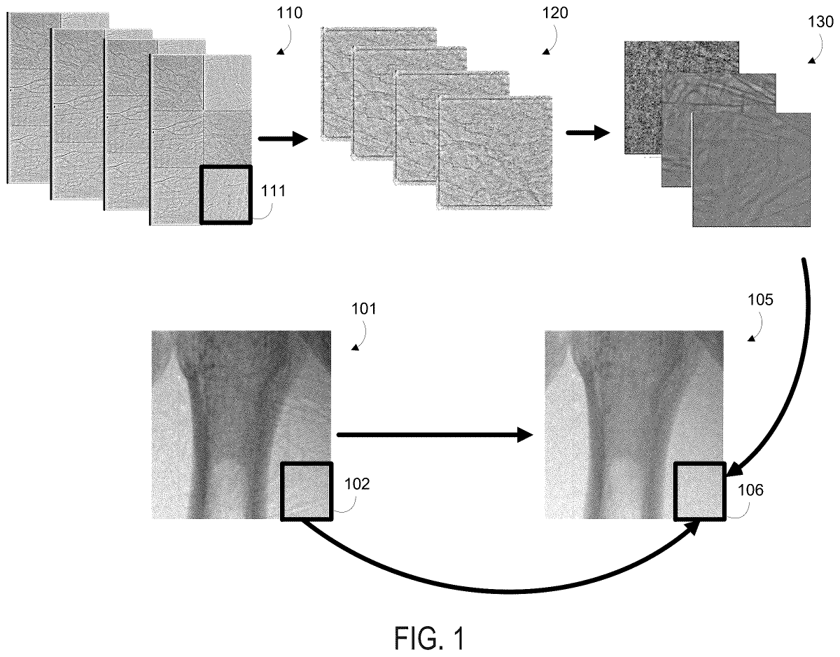

FIG. 1 depicts aspects of such a process, including examples of the calibration and other images used as part of the process. A set of whole-sensor calibration source images 110 are generated using an imager (e.g., a multi-tile imager, comprising multiple different tile image sensors assembled into an overall image sensor). The calibration and correction processes described herein are performed on a per-tile basis for multi-tile image sensors; so, for example, portions of the whole-sensor calibration source images 110 corresponding to the lower-right tile 111 of the image sensor are selected (e.g., cropped from the whole-sensor calibration source images 110) and translated into logarithmic space (e.g., by applying a natural log function or other log function thereto in a pixel-wise manner) into tile-specific logarithmic calibration source images 120. A set of tile-specific logarithmic calibration basis images 130 are then determined from the population of tile-specific logarithmic calibration source images 120 such that most or all of the vein-related variation in the population of tile-specific calibration source images 111 is represented by the set of logarithmic calibration basis images 130 (e.g., such that any one of the of tile-specific calibration source images 111 can be completely, or nearly completely, obtained as the exponentiation of a weighted combination of the logarithmic calibration basis images 130). Then, to remove the vein artifacts from a target image 101, for each tile 102 a weighted combination of the tile-specific logarithmic calibration basis images 130 can be determined and subtracted, in log space, from the tile-specific portion 102 of the target image 101 to generate the corresponding corrected tile-specific portion 106 of the corrected image 105 that contains no, or a reduced amount, of vein artifact image contents. This process is repeated for each tile, to correct the full image.

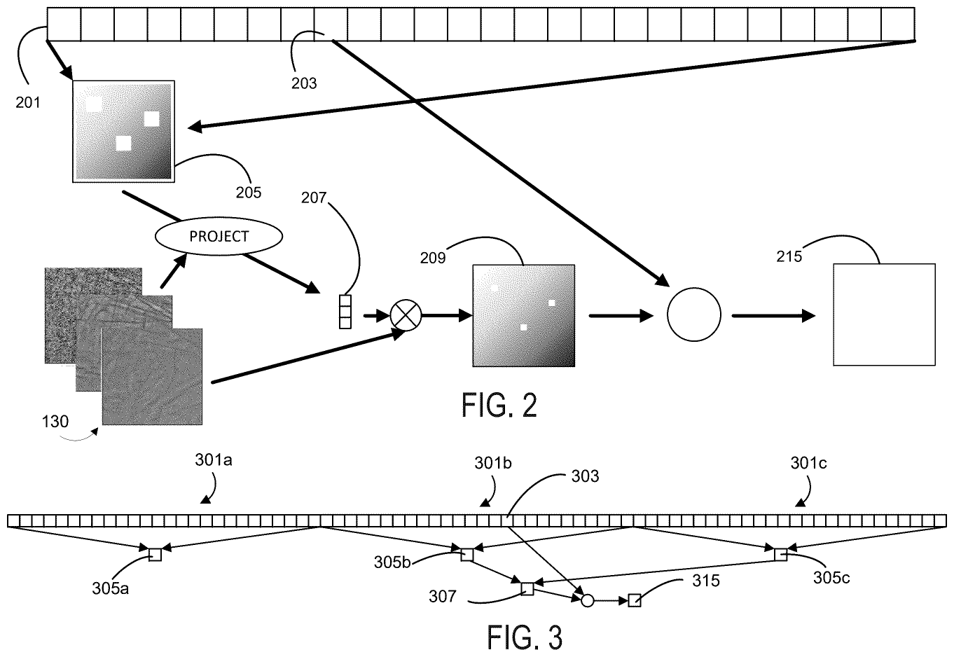

FIG. 2 depicts additional aspects of such a vein correction process for a single tile of a multi-tile sensor. A set of one or more scan images 201 of a body part or other object, which includes a target image 203, are obtained from an image sensor (e.g., from a single tile of an image sensor). The data is then pixelwise aggregated across the set of scan images 201 (such as, for each pixel, taking the mean across a set of frames, or the median, or the truncated mean, or some other type of average, etc., or optionally the method can be performed based on the single image 201 alone, without aggregation), and the logarithm determined thereof to generate a block image 205. This can be done after applying various other artifact or noise-correction image processing tasks on the scan images 201, e.g., pulse pile-up artifact correction, bad pixel artifact correction (e.g., setting a set of bad pixels to a default value, inpainting such pixels based on nearby pixels, or some other bad pixel correction). Additionally or alternatively, the generation of the block image 205 may comprise the application of a filter to emphasize veins and/or other artifact contents therein and/or to de-emphasize contents likely to accurately represent the body part or other object of the imaging scan (e.g., a high-pass filter could be applied to emphasize the high-spatial-frequency contents of the images, which are more likely to represent vein artifacts).

The ordering of aggregation, logarithm, and/or filtering steps used to generate image 205 could be selected according to an application. This specific ordering (aggregation, then logarithm or other nonlinear function application, then filtering) has the advantages of good noise handling (by aggregating first), fast processing (by filtering after aggregating), and algorithmic correctness (by doing the filtering after the logarithm or other projection, and thus in the same space as the projection operation). Note that the filtering step affects the block image 205, but not the target image 203. Optionally, the filtering operation may be rolled into the projection operation, without separately filtering the pixel values in 205. Or equivalently, the filtering step may be performed by suitably pre-filtering the basis images before the projection operator, as part of the generation of weights 207, while reserving an unfiltered copy of the basis images to use in generating the artifact image 209 from the weights 207. The choice depends on the desired tradeoff between speed (where pre-filtering the bases is generally fastest) versus flexibility (where filtering at runtime allows things like the filter or the bad pixel list to change dynamically throughout the course of the scan).

The block image 205 is then projected onto the set of logarithmic calibration basis images 130 for the image sensor. This results in a set of weights 207, which define a weighted combination of the logarithmic calibration basis images 130 that represents the vein artifact in the block image 205. The logarithmic calibration basis images 130 can then be combined, according to the set of weights 207, to generate a weighted combination of the logarithmic calibration basis images 209 that represents the vein artifact in the target image 203. The weighted combination of the logarithmic calibration basis images 209 can then be subtracted, in log space, from the target image 203 to generate a corrected image 215 that has the vein artifacts removed or reduced. Such subtraction can include determining a log of the target image 203, subtracting the weighted combination of the logarithmic calibration basis images 209 therefrom, and then exponentiating or otherwise converting the difference back into a non-logarithmic linear image space. Such an approach can be advantageous for speed when the logarithm of 203 is already available, such as when the set of scan images 201 is just a single image 203. Alternatively, the weighted combination of the logarithmic calibration basis images 209 can be used to generate a scaling image (e.g., by performing a pixel-wise exponentiation of the weighted combination of the logarithmic calibration basis images 209) which is then pixel-wise multiplied (or divided, depending on sign convention, though typically multiplication is preferred for speed) with the target image 203 to generate the corrected image 215. Such an approach can be advantageous for speed when a single basis set 209 will be used on multiple images 203 and/or the log of the target image 203 isn't already available.

Some types of artifacts (such as vein artifacts) vary over some particular time scale that may be longer than a frame but shorter than a full scan of multiple frames. Therefore it can be advantageous to choose the block size as a number small enough to fully capture that time variation (e.g., without ‘aliasing’ the variation by using too large a block size, and thus ‘undersampling’ the artifact variation). Yet the block values of the set of scan images 201, the set of weights 207, and the logarithmic calibration basis images 209 can also be susceptible to noise, which can be reduced by the aggregation step, with larger block sizes generally resulting in reduced noise levels. Additionally, as block size is increased, processing latency will generally worsen (e.g., due to the wait for the frames of the larger blocks to be acquired), while overall processing throughput will generally improve (e.g., due to fewer weight determinations and weighted combinations being performed over time, due to there being fewer, longer blocks per unit time). The block size is also limited by the total number of available frames. For scanners that involve a motion stage (e.g. for CT, or on a conveyor belt), large blocks can also be helpful to ‘smear out’ the ‘true’ object image data over space, reducing false positive matches with the calibrated basis images that might then remove aspects of the object from the output image data. Thus there are many factors having effects on the choice of block size. For some practical applications, a block size of 100 frames is a reasonable compromise value, though the block size may additionally or alternatively be determined based on factors such as frame rate, latency, or desired throughput.

The methods described herein could be expanded to determine sets of weights and/or weighted combinations of the logarithmic calibration basis images for respective different blocks of scan images (e.g., non-overlapping blocks of scan images) and then combinations of these sets of weights and/or weighted combinations of the calibration logarithmic basis images could be determined to correct vein artifacts in a particular target image.

FIG. 3 depicts aspects of such a method, wherein three different weighted combinations of the logarithmic calibration basis images 305a, 305b, 305c are generated based on respective logarithms of means across respective sets of images 301a, 301b, 301c (e.g., non-overlapping sets of images, which may or may not be separated by ‘gap’ images).

These weighted combinations of the logarithmic calibration basis images 305a, 305b, 305c (or, alternatively, their respective underlying sets of weights for the basis images) could then be combined to generate an overall weighted combination of the logarithmic calibration basis images 307 that can then be used to remove (e.g., by pixelwise multiplication by a scaling matrix, or by subtraction in log image space) vein artifacts for a target image 303. Such combination can include linearly or nonlinearly (e.g., according to a quadratic, spline, or other weighting) weighting the weighted combinations of the logarithmic calibration basis images 305a, 305b, 305c according to the timing of the target image 303 relative to the timing of each of the sets of images 301a, 301b, 301c. In practice, for computational efficiency, a single set of weighted combinations of the logarithmic calibration basis images can be used to correct a number of different target images (e.g., 303). For example, when using linear interpolation weighted by block mean time, the target image 303 could be corrected by a weighted average of the two correction images 305b and 305c that are closest in time to 202 (i.e., without using 305a), weighted by the distance in frames (or time) between the target image 303 and the mean time of 305b and the mean time of 305c.

In FIG. 3, the sets of images 301a and 301b and 301c are illustrated to be contiguous and non-overlapping. Alternatively, the sets could be overlapping, in order to further reduce noise and/or to avoid ‘aliasing’ of the underlying artifact dynamics. Or the sets could be non-contiguous (with a gap between each set), in order to reduce computation time. Note that each target image 303 might be a member of one set, or multiple sets (which can happen in the case of overlapping sets), or no sets (which can happen in the case where there are gaps between sets).

The embodiments described herein are also improved in that they allow more pixels to be corrected by the weighted combination of logarithmic basis images than were used to estimate the weighting thereof. In prior methods, a variety of ad hoc corrections were applied both before determining the weighting of a calibration image to estimate the vein artifacts in a target image, as well as to apply additional corrections to the vein estimate prior to applying it to remove such artifacts from a target image. These processes made it difficult or impossible to correct pixels of the image sensor that were not also used to estimate the vein correction image, or similarly to correct good pixels without corrupting their correction with the influence of nearby bad pixels. This is particularly limiting where various filters may be applied (e.g., to emphasize vein structure in the input image(s)) prior to determining the vein artifact estimate, since such filtering steps can ‘dilate’ the effects of small sets of bad pixels across large areas of nearby pixels, thereby preventing those large areas of pixels from being effectively corrected for vein artifacts. Additionally, the detector may include some “weird” pixels that are less reliable than other pixels (e.g., than ‘bad’ pixels) but that may still represent usable artifact image data. For example, pixels along the border of each tile may behave different than pixels in the interior. It can be desirable to correct such weird pixel values in order to maintain the usability of their values, while also avoiding their use to correct ‘good’ (i.e., not ‘bad’ and not ‘weird’) pixel values. It can be difficult to achieve both goals simultaneously. One solution is to inpaint over bad or weird pixel values prior to performing these corrections, but that can result in lost information for both the object being scanned and for the vein pattern to be estimated.

In contrast, the methods described herein allow different, broader sets of pixels to be corrected by a vein estimate than are used to determine the weighting of logarithmic basis images used to generate the vein estimate. This is depicted schematically in FIG. 2 by the “white” portions of the block image 205 and weighted combination of the logarithmic calibration basis images 209. White portions in 205 represent pixels that are ‘bad’ or ‘weird’ or nearby to pixels that are bad or weird (e.g., disabled pixels, or pixels within a specified distance of the edge of a sensor tile). White portions in 209 represent pixels that are bad. So, for example, the whited out pixels of the block image 205 are not used to determine the weighted combination of the set of weights 207 of the basis images 130, and whited out pixels of the weighted combination of the logarithmic calibration basis images 209 are not determined from the set of logarithmic calibration basis images 130 (such pixels could be, instead, set to a default correction value (e.g., representing a unity scaling of corresponding pixels of the target image 203), or inpainted from neighboring pixels). As shown in FIG. 2, the whited out portions of the weighted combination of the logarithmic calibration basis images 209 are smaller than the whited out portions of the block image 205, indicating that more pixels of the target image 203 are able to be corrected by corresponding pixels of the weighted combination of the logarithmic calibration basis images 209 that were used from the block image 205 to estimate the weighted combination of the logarithmic calibration basis images 209. Similarly, more pixels of the image sensor could be used to generate the set of logarithmic calibration basis images 130 than are used to estimate the weighted combination of the logarithmic calibration basis images (due, e.g., to no pre-emphasis filtering being applied to the calibration images before using them to generate the logarithmic basis images, and thus the erroneous effects of any bad pixels not being spread across nearby pixels by such a filter).

It may also be desirable to generate a best guess artifact estimate for every pixel in the weighted combination of the logarithmic calibration basis images 209, such that there would be effectively no white portions in 209. For example, a user-facing map of bad and weird pixels could be automatically dilated to form a dilated map (e.g., by extending the set of bad and weird pixels by a set number of pixels). The filter and this dilated map can then both be applied to the block image 205 and to the calibration basis set 130 to respectively produce a masked filtered block image and a set of masked filtered calibration basis images. The masked filtered block image is projected based on the masked filtered calibration basis images to produce basis coefficients 207. Those coefficients 207 are then expanded on the non-filtered and non-masked calibration basis images 130 to produce the weighted combination of the logarithmic calibration basis images 209, which may thus contain a viable artifact estimate for every pixel, including bad or weird ones. In such an example, the coefficients 207 are independent of the pixel information of the bad pixels, weird pixels, and pixels within the dilation distance of bad or weird pixels, and thus the artifact estimate image 209 is uncorrupted by weird or bad pixel values, but still includes an estimate for all pixels, allowing all pixel values in 215 to be corrected. For truly ‘bad’ pixels, the pixel values in 215 may be unusable and may be inpainted downstream. However, for weird pixels (e.g. for tile edge pixels) the pixel values in 215 may be improved and usable, and might even be considered good (instead of ‘weird’ or otherwise less trustworthy) for downstream processing.

To generate the set of logarithmic calibration basis images, a set of calibration source images can be obtained by using the image sensor to image a number of different calibration objects/scenarios. For example, sets of calibration source images could be obtained for air, for one or more uniform slabs of Lucite (e.g., at respective different thicknesses), for one or more uniform foils or plates of aluminum or some other metal (e.g., at respective different thicknesses), and/or for some other uniform target object. The sets of scans of each target object could be performed over a range of operating conditions, e.g., temperatures, scan lengths, etc. such that the set of calibration source images exhibits a rich and full representation of the possible ways that the image sensor can exhibit vein artifacts, and thus such that a complete estimate of that behavior can be determined therefrom as a set of logarithmic calibration basis images. By one approach, calibration images of the target uniform object can be corrected for certain physics effects such as beam shape, 1/R² effects (where X-ray fluence falls off with the square of the distance from the source), 1/cos effects (where path length through a slab of material depends on the X-ray angle relative to the slab's normal direction), and/or other effects so that any remaining non-flatness in the corrected image can be assumed to represent the artifacts to be corrected. By another approach, such physics effects may be ignored and not corrected (e.g. if the angular spans of the tiles are small enough that those physics effects can be considered functionally constant over the span of any single tile).

Determining the set of calibration basis images could include determining such images based on a subset of the pixels of the image sensor, e.g., based on image information from pixels of the image sensor that are i) not marked as ‘bad’ (due to, e.g., being ‘stuck’ on a specific output value, exhibiting high noise, or otherwise exhibiting invalid behavior), and ii) not marked as ‘weird’, such as being within a specified distance (e.g., number of pixels, or distance in mm) of a physical edge of the image sensor (e.g., of a tile of the image sensor). This can be represented as attempting to represent, in the form of a restricted set of logarithmic basis images, W_{c}C, where C is a matrix of the logarithm of vectors representing the logarithm of the calibration source images and W_{c} is a weighting matrix that provides ‘0’ (or some other small value) to pixels that are bad, near the tile edge, or otherwise not to be used in determining the basis images and ‘1’ (or some other appropriate value) to pixels otherwise. Optionally, weights between 0 and 1 can be used to indicate that a pixel is not totally unusable, but its data is not as trustworthy as a fully good pixel. By one approach, the bad pixel map is determined at calibration time and/or by the known detector geometry, and thus the weighting matrix is known and fixed before the object data is acquired. By another approach, bad pixels are detected at run-time (for example by comparing local statistics for each pixel vs their neighbors, or by detecting illegal values such as pre-log values that are negative or near-zero or saturated) and the weighting matrix thus able to change throughout the scan. These approaches can also be combined, where a bad pixel map is determined statically during calibration, but then additional bad pixels are detected dynamically at runtime.

Determining the set of logarithmic calibration basis images from the specified subset of pixels of the set of logarithmic calibration source images can be performed in a variety of ways. For example, singular value decomposition could be used to decompose the set of calibration source images into a set of basis images (e.g., orthogonal basis images, such as principle components) that are ordered with respect to their contribution to the total image content (e.g., energy) in the set of calibration source images. The ‘top’ basis images could then be selected as the set of logarithmic calibration basis images. In one or more example, such ‘top’ images could represent all of the image contents in the set of logarithmic calibration source images, so that the set of logarithmic calibration source images is fully represented by the set of logarithmic calibration basis images. Alternatively, the selection of the ‘top’ images could truncate some of the image contents or information, leading the set of basis images to approximately represent the set of logarithmic calibration source images. The number of basis images retained as the set of logarithmic calibration basis images could be selected in a variety of ways, e.g., as a user input, based on the proportion of image contents (e.g., energy) represented by the set of selected basis images (e.g., such that more than a threshold fraction of the image contents is represented by the set of selected basis images), based on the singular values vector (or matrix) of the singular value decomposition used to generate the basis images (e.g., discarding basis images whose singular values are less than a threshold fraction of a maximal singular value of the set of singular values, or are less than a threshold fraction of the sum of all the singular values), and/or some other method or combination of methods to select a subset of the basis images generated via singular value decomposition and/or some other subspace identification method. Alternatively, one could arbitrarily specify a desired number of basis images, such as 5, 10, or 20.

Once the logarithmic calibration basis images have been obtained for an image sensor (e.g., for a particular tile of a multi-tile image sensor), a weighted combination thereof can be determined as an estimate of the specific vein artifact present in a particular image and used to reduce or remove that artifact therefrom. As noted above, this can include determining, for a block of production images, a block image as a logarithm of a pixelwise mean thereof. Such a block image could then be projected onto the set of calibration images to determine, for the target image, a weighted combination of the calibration basis images. Such a process could be performed a number of times, for a number of different blocks of production images, to generate respective weighted combinations of the calibration basis images which could then be combined (e.g., based on a timing of the target image relative to a mean or other timing value for the blocks of production images) to generate an overall weighted combination of the calibration basis images for the target image, which can then be subtracted therefrom (in log image space) in order to reduce or remove the vein artifact from the target image.

As noted above, such a projection of a block image onto the set of logarithmic calibration basis images could be performed after applying a filter to emphasize vein-related image contents of the block image (and/or of the individual images averaged together to generate the block image). Additionally or alternatively, such a projection could be performed based on a subset of the pixels of the block image that differs from the set of pixels used to generate the calibration basis images and/or the set of pixels to be corrected based on the projection. This can be represented as attempting to determine a vector b of weights for the logarithmic calibration basis images by minimizing the difference (e.g., the L2 norm of) WₚFy—WₚFUb, where U is a matrix of vectors representing the logarithmic calibration basis images, y is a vector representing the block image (which is in logarithmic image space), F is a vein-emphasizing filter, and Wₚ is a weighting matrix.

Such a weighting matrix could i) provide ‘0’ (or some other small value) to pixels that are bad and to a set of pixels within a distance of bad pixels (e.g., pixels within a kernel length of the filter F of bad pixels), pixels near the physical or logical tile edge, or pixels otherwise not to be used at all in determining the projection, ii) some other sub-unity value (e.g., ‘0,’ or a linear or other pattern of feathering from ‘0’ next to ‘bad’ pixels up to ‘1’ or some other appropriate value next to ‘good’ pixels) for pixels within another distance (e.g., another length of the filter F) of the set of bad and near-bad pixels, and iii) ‘1’ (or some other appropriate value) to pixels otherwise.

A variety of different filters could be used to emphasize vein-like contents in the block image. For example, a Laplacian of Gaussian (LoG) filter could be used. As noted elsewhere herein, the specifics of the filter could be selected in order to facilitate other simplifications and/or improvements to the methods described herein, e.g., to reduce the computational cost thereof, to numerically stabilize the method, and/or to allow aspects of the method to be pre-computed into a reusable matrix or other representation of the weighting, filter, set of basis vectors, and/or other aspects of the method such that projection of a block image onto the set of basis vectors can be accomplished via a single matrix multiplication with such a pre-computed matrix. For example, the filter F could be even-symmetric, or odd-symmetric, and could be applied with zero-padding.

Once the vector of weights b has been determined, it can be used to generate a weighted combination of the logarithmic basis images, which can then be subtracted (in logarithmic image space) from a target image (optionally after combination with weighted combinations determined from other block images). This can be represented as a=Ub, with a being a vector representing the weighted combination of the logarithmic calibration basis images, which can be subtracted from a target image by either determining the logarithm of the target image, subtracting a therefrom, and then reversing the logarithm to return the corrected target image into the linear image space, or by determining a scaling matrix as c=e^{-a} and then pixelwise multiplying that scaling matrix by the target image.

As noted above, several aspects of the above method could be combined into a single matric multiplication or other computationally reduced-cost operation by determining, from the filter(s), weighting matric(es), sets of logarithmic calibration basis images, and/or other aspects of the process one or more projection matrices. For example, the process of filtering the block image, weighting the pixels of the block image, and then projecting a first subset of pixels (e.g., pixels outside of a first distance from ‘bad’ pixels, and optionally a fractionally weighted projection of ‘weird’ pixels that are more than a second, shorter distance from the ‘bad’ pixels, but less than the first distance) of the block image onto the set of calibration basis images according to the weighting to determine a weighting vector could be implemented as a single matrix multiplication of the block image by a pre-computed projection matrix. This can be represented by b=(Gy), where G is a pre-computed projection matrix determined based on F, U, Wₚ, and optionally some additional factors or inputs (e.g., a regularization constant selected to stabilize the computation of G numerically). If those elements (the filter F, the set of logarithmic calibration basis images U, and the projection weighting matrix Wₚ) are fixed throughout the imaging session, then for each tile G can be pre-computed and then efficiently applied via matrix multiplication to the block images for different blocks of production images to generate therefor respective weighted combinations of the logarithmic calibration basis images that represent respective vein artifact patterns represented therein. Such a projection matrix G can be computed in a variety of ways, e.g., as described elsewhere herein. Alternatively, the G matrix can be omitted and F, U, and Wₚ can be applied directly, which can be useful if it is desired to support the weights and/or filter changing dynamically or adaptively during the correction. Optionally, a DC restoration step may also be incorporated to adjust the correction's effect on DC value.

The methods described herein are able to provide removal of vein artifacts from images in a manner that is improved with respect to computational cost, the subjective quality of images corrected thereby, the number of images used to generate an accurate estimate of the pattern of vein artifacts therein, the amount of pixels of an image that can be corrected, the complexity and number of free parameters specifying the particulars of the method, and other beneficial factors.

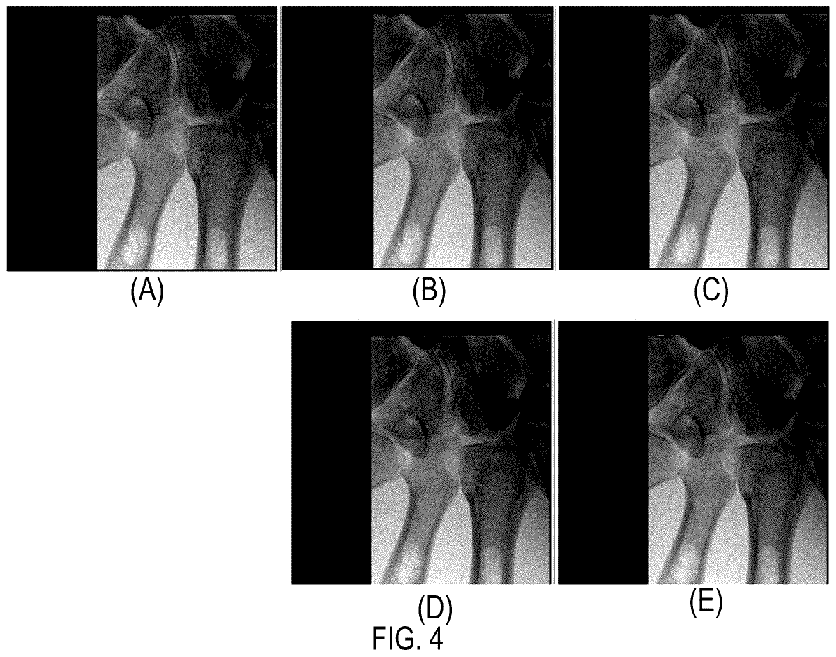

FIG. 4 depicts various versions of a target image (image (A)) corrected via some or all of the methods described herein. Images (B) and (C) were corrected by, in linear image space, projecting a set of pixels of a block of production images onto a set of calibration basis images and then subtracting, in linear image space, the weighted combination of the basis images from the target image. Image (D) was corrected by, in logarithmic image space, projecting a set of pixels of a block of logarithmic production images onto a set of logarithmic calibration basis images and then subtracting, in logarithmic image space, the weighted combination of the logarithmic basis images from the target image. Image (E) was corrected by, in logarithmic image space, projecting a first set of pixels of a block of logarithmic production images onto a set of logarithmic calibration basis images and then subtracting, in logarithmic image space, the weighted combination of the logarithmic basis images from the target image to correct more pixels of the target image than were used to estimate the weighted combination.

Throughout the present disclosure, various methods are described to remove veins and other dynamic artifacts from images. In certain examples, embodiments may be described as specifically removing vein artifacts, or the properties of vein artifacts and their correction may be specifically described. Unless context indicates otherwise, one of skill in the art will appreciate that such artifact correction techniques or other aspects of this disclosure may be applied, with corrections as necessary, to the properties of or aspects of the removal of other types of dynamic artifact (e.g., that exhibit similar temporal and/or spatial properties to vein artifacts and/or that exhibit complex, multi-dimensional dependencies on hidden variables of image sensors) without departing from the scope of this disclosure.

### II. Experimental and Theoretical Implementations and Verification

As noted above, veins are a common artifact in direct conversion detectors. These artifacts can be caused by a variety of processes, including but not limited to dynamic shifts in the effective location of the stopping area for each pixel, since when the “edge” of a pixel moves, then some of the charge that would have been collected by a particular pixel can be diverted to or from neighboring pixels. This can happen when the effective location of a pixel is defined electrically, rather than mechanically, and thus the electrical edge of a pixel can move as a function of temperature, charge, or other factors. Techniques are provided herein to correct for such vein artifacts. These techniques include performing an initial calibration step for an image sensor (e.g., for an image tile of a multi-tile image sensor) to characterize the vein artifacts in advance with respect to the ways that they may vary over time, e.g., due to changes in temperature, accumulated charge, electrical fields, or other time-varying factors. These techniques can be implemented using only image pixel data, without additional measurements (e.g., tile sensor temperature measurements).

In this section, unless indicated otherwise:
log x means natural log unless another base is explicitly stated;
⊙ means element-wise multiplication, so z=x⊙y for vectors x, y, z is the same as zᵢ=xᵢyᵢ∀ᵢ;
≙ is a definition (rather than a derivation); and
I is the identity matrix.

The methods described herein generally include a number of high-level steps or phases, including:

Subspace Identification: finding a subspace (e.g., a minimal subspace) in the space of possible sensor output images that, at least approximately, spans all the possible vein artifacts but no (or little) more than that. This may be referred to as “calibration” for a particular image sensor (e.g., for a tile of a particular image sensor).

Subspace Projection: for a given target image (of object+veins), projecting the image onto the vein subspace, to find an image that represents only the veins (and not the object) in the target image.

Vein subtraction: removing (e.g., by subtraction in logarithmic image space) the vein estimate from the target image.

The ‘calibration’ aspect of these methods can be implemented in a variety of ways, including by:

Taking a plurality flood-field or otherwise ‘neutral’ calibration scan(s), for example unfiltered scan(s) of air, scan(s) of a constant-thickness lucite or otherwise composed filter, scan(s) of different thicknesses of lucite, scan(s) of constant thicknesses of copper, etc.

Optionally averaging bins of frames to reduce the data size.

Correcting the calibration scan(s) for everything but veins, so that all or substantially all of the remaining image content is vein artifacts.

Performing subspace identification on the corrected calibration images.

The ‘correction’ aspect of these methods, to remove vein artifacts from a ‘production’ image (e.g., of a body part of a patient) can also be implemented in a variety of ways, including by:

Obtaining the subspace characterization of the image sensor (e.g., as a set of basis images, which may be in log image space) from the calibration method.

Imaging an object a plurality of times to generate a plurality of images thereof, and pre-correcting the images for non-vein artifacts and/or noise sources.

Grouping the images into blocks, and for each block projecting the entire block onto the subspace. This can result in an image of the veins as they persisted through the entire block of images.

For a target image (e.g., each of the plurality of images), interpolating the projected vein image(s) from the nearest block(s) to find an estimated vein image of the veins as they occur in the target image. This estimated vein estimate is then removed (e.g., by subtracting in log image space, by scaling the target image by a scaling image that represents the vein estimate) from the target image to get a corrected target image.

As noted above, many artifact mechanisms, such as the vein artifact mechanism, exhibit gain-like behaviors, so the vein subspace characterization and “subtraction” are performed on the logarithm of the image data (as noted above, either by performing subtractions between logarithmic representations of images/vein estimates, or by scaling target images by scaling ‘images’ that represent the vein estimates in a manner that results in their being functionally subtracted in log image space by pixel-wise scaling the target image by the scaling ‘image’).

A pre-emphasis filter can be used to cause the subspace projection to emphasize veins and de-emphasize non-vein-like image contents.

The imager may have ‘bad’ pixels or other types of pixel that exhibit noisy or otherwise erroneous outputs (and thus which may be less reliable for, e.g., predicting the specific vein contents of an image). Additionally, pixels near sensor tile edges may behave differently from other pixels. The subspace identification and projection steps described herein can both account for this, so that such “weird” pixel values from pixels that are bad or otherwise exhibit ‘strange’ behavior don't corrupt the subspace identification or projection, which can then be used to determine a correction for ‘good’ pixels (and, optionally, for some of the ‘weird’ pixels).

For the purposes of the exemplary embodiments of this section, consider a single image tile of size Nᵤ×Nᵥ, and say that we have K images generated by the image tile. Then define:
A “tile image” is a 2D Nᵤ×Nᵥ image of pixel values;
A “tile image stack” is a 3D data set comprising a stack of 2D images, with total size Nᵤ×Nᵥ×K;
A “tile vector” is a 1D column vector of size (NᵤNᵥ)×1, whose contents are a single unrolled tile image;
A “tile matrix” is a matrix of size (NᵤNᵥ)×K, where each column is a tile vector for a single image in the stack, and there are K columns (one for each image in the stack).

Note that the memory storage of a tile image and tile vector can in some cases be made identical. For example, in computer memory, a pointer to a tightly packed tile image can be reinterpreted as a pointer to a tile vector, and vice versa, without any memory copying. Similarly, when using column-major matrix storage, the memory storage of a tightly packed tile image stack is the same as for its corresponding tile matrix, and a pointer to either may be reinterpreted as the other. The specific mathematical implementations below will, generally, treat images as vectors and matrices, with the understanding that in an actual implementation, some steps may as appropriate re-interpret vectors as images, and/or matrices as image stacks.

Assume the existence of a stack of calibration images (pre-processed, logged, and possibly time-binned, spanning a reasonable variety of imaging conditions and calibration image targets to fully represent variation in the vein artifacts of the imager) and a block of scan images to be corrected. Also assume an input “knot” image as the aggregate image (e.g., mean image) of the block of scan images (where aggregation is performed in the frame direction). To simplify explication herein, the specific example of aggregating by, for each pixel, taking the mean in the frame direction will be used. However, other aggregations could be used instead, such as median, truncated mean, or some other type of average. Then define:
C=a tile matrix of the logged calibration frames, corrected for other artifacts and optionally flattened, so essentially all that is left is veins.
y=a tile vector holding the input knot image. This is the log of the mean of a block of measured scan images (corrected, prior to taking the mean, for one or more other types of noise or artifact other than veins (or some other dynamic artifact of interest)).
x=a tile vector holding the log of the ‘true’ object image data (without veins) for the knot. This is a theoretical vector and cannot be measured directly (the process of vein correction can be characterized as trying to recover x from y).
a=a tile vector holding an image of the veins' contribution to the input knot image, so y=x+a. A primary goal of subspace identification and projection is to recover a from y.
F=some linear pre-emphasis filter that emphasizes veins and de-emphasizes object structure.
W=a diagonal weighting matrix whose diagonal is a tile vector corresponding to an image of tile weights (and whose off-diagonal elements are zero). The tile weights are 0 for pixels whose value won't be used in the corresponding step, and non-zero for pixels that will be used. By one approach, the weights are binary, where pixels will either be used (with weight 1.0) or unused (with weight zero). By another approach, the weights are a continuous indication of ‘trustworthiness,’ where the value is higher for more trustworthy pixels and lower for less trustworthy pixels (e.g., zero for pixels that are completely untrustworthy). Different W matrices may be used for different aspects of the method described herein, and their weights may be chosen slightly differently.
W_{c} for subspace identification from the calibration images, An example implementation could use a binary weighting, with ‘good’ pixels having weight 1.0 and ‘bad’ or ‘weird’ pixels having weight 0.
Wₚ for subspace projection onto the calibration images from a ‘knot’ image or other scan imagery. A example implementation begins with a Boolean mask of bad and weird pixels (i.e., with the bad and weird pixels having value zero, or some other specified low value, and other pixels having values of 1 or some other high value). Some form of dilation or similar operation (e.g., proportional in length to the filter length) can then be applied to dilate the Boolean mask (i.e., to expand the set of low-value pixels outward from the initial set of bad and weird pixels). The dilated mask can result io a binary weighting; in another example, such a binary weighting could then be ‘eroded’; in yet another example, a binary weighting can then be convolved with an appropriate feathering kernel, to allow the values of the weighting matrix to gradually (e.g., linearly) change from a region of pixels of low value to a region of pixels of high value.
Wₛ for vein subtraction from a target image (typically, Wₛ=I, though other options are possible).
U=a basis matrix spanning the veins. Specifically, by “spanning the veins,” it is meant that U is defined such that for any physically reasonable vein image a, there is some b such that, at least approximately, a=Ub.
G=an optional analysis matrix for optimized or otherwise improved weighted projection (e.g., according to principal components analysis, “PCA”). Specifically, U and G are defined such that for any y=x+a, the veins can be recovered by using a≈UGy.

The method, without the additional complication of weights or filters, is:

For subspace identification, the goal is to find a U matrix where U spans all of C. In other words, a U such that there is some matrix B such that C≈UB. If the calibration images were properly taken to cover a good range of expected detector states (and thus of possible vein behaviors/images), then it is reasonable to expect that if U spans C then U will also span any future vein image a.

The span of U is selected to be as small as possible (or equivalently the rank of U is as low as possible, or the nullspace of U is as large as possible) while still spanning all (or substantially all) of the observed C.

Note that the standard mathematical definition of a “basis” matrix is one that spans a desired subspace, and for which all of its columns are orthogonal. The term as used herein is looser, referring more generally to the U matrix, whatever it is. In practice U's columns will typically be at least approximately orthogonal (and exactly orthogonal if W=1), but that is not actually required for the algorithm described herein to provide the benefits described herein.

In subspace projection, given some U matrix and some y vector, the goal is to analyze y to estimate a, where a is restricted to subspace U. Equivalently, the goal is to process y to find a vector b such that a≈Ub and a represents the vein artifacts present in y. By one approach, this can be performed efficiently by using an analysis matrix G to calculate b=Gy.

The final correction step can then subtract a from y to recover x (for example, by estimating a from a block of frames, and then using this estimate to correct individual target image frames).

Adding the complication of filtering and weights:

In subspace identification, the weights are used to judge the subspace. Without weights there is some B for which C≈UB, while with weights this becomes W_{c}C≈W_{c}UB, for example in a way that gives reasonable values even for pixels where W_{c}=0. Note that the unweighted case is a special case of the weighted case, with all weights set to 1.0.

In subspace projection, the goal is to process y determine a vector b such that WₚFa≈WₚFUb and a represents the vein artifacts present in y. Note that the unweighted unfiltered case is a special case of the filtered weighted case, using unity weighting and an identity filter.

Consider a tile with Nₚ total pixels in it (if the tile is of size Nᵤ×Nᵥ then Nₚ=NᵤNᵥ), and assume the existence of N, calibration frames. Then each column of C holds an unrolled tile image, and the matrix C is of size Nₚ×N_{c}. Let Nₘ=min{Nₚ,N_{c}} (in practice this will often be Nₘ=N_{c}). Also define r=rank(C), and note that r≤Nₘ.

Find a low-rank matrix U⁻ that has approximately the same span as C for pixels with non-zero weight, or that has approximately the same span as W_{c}C. There are a number of Principle Component Analysis (PCA) algorithms and PCA-like algorithms that can be used for this, though other methods may also be applied. One simple but effective choice is the singular value decomposition (SVD). If all input data is reliable (e.g. if bad pixels are properly de-weighted and there is no significant impulse noise), then SVD is an effective and attractive choice. However SVD is based on squared error and thus can be sensitive to outliers, so if there is unreliable data with non-zero weighting then other methods may be preferable such as Robust PCA (RPCA), Weighted PCA (WPCA), Robust Subspace Learning, L1-SVD, or similar. The SVD approach will be described in detail herein as an illustrative example. Perform the SVD on the matrix W_{c}C and call the resulting matrices Ū, S̅, and V̅. By a common definition of SVD, [symbol] is a diagonal matrix whose diagonal has non-negative values stored in decreasing order, [symbol] is orthonormal, [symbol] is orthonormal, and

[symbol]

[symbol]

[symbol]

=W_{c}C. (1.1)

Additionally, r can be measured as the number of non-zero elements in [symbol] .

The size of each matrix depends on the specific variety of SVD (e.g. depending on computational library used). Common forms include: [symbol]
Full SVD: [symbol] is Nₚ×Nₚ, and [symbol] is Nₚ×N_{c}, and [symbol] is N_{c}×N_{c}.
Thin SVD: [symbol] is Nₚ×Nₘ, and [symbol] is Nₘ×Nₘ, and [symbol] is N_{c}×Nₘ.
Compact SVD: [symbol] is Nₚ×r, and [symbol] is r×r, and [symbol] is N_{c}×r, and all diagonal entries of S are positive (non-zero).

Any of these forms are acceptable since in all examples they will be truncated to the same size (though Thin and Compact are more efficient since they will have fewer extra columns to truncate). Next we will reduce the number of columns in U from N_{c} to N_{b}. By one approach, N_{b} is a user parameter that is fixed ahead of time. By another approach, N_{b} is chosen by the algorithm, automatically finding the minimum number of bases to capture the span of C to some specified suitable level of accuracy. Note there is yet another variety of SVD, the Truncated SVD, which only calculates a desired number of bases—this may be even more efficient since it can avoid calculating the unwanted columns to begin with, such as directly yielding the U\hat{ }, S\hat{ }, and V\hat{ } matrices below.

Assume a set of bases determined via some form of SVD (such as Thin SVD). Then choose some number of bases N_{b}, crop the SVD down to the first N_{b} bases, and call the resulting matrices Û, Ŝ, \hat{V}. Specifically, these are constructed as U\hat{ }= [symbol] [:,1:N_{b}], and S\hat{ }= [symbol] [1:N_{b},1:N_{b}], and V\hat{ }= [symbol] [:,1:N_{b}]. Then U\hat{ } is Nₚ×N_{b}, and S\hat{ } is N_{b}×N_{b}, and V\hat{ } is N_{c}×N_{b}. Then

U\hat{ }S\hat{ }V\hat{ }^{t}=WcC. (1.2)

where the error in the approximation is proportional to the total truncated energy that was in [symbol] but that was removed from S\hat{ }. If N_{b}≥r, or equivalently if no energy was truncated, then (1.2) holds with exact equality.

By one approach, which is typical for SVD implementations of PCA, one can simply use U=U\hat{ }. However, that leaves the weights embedded in the basis images, and could prevent the algorithm from finding vein artifact estimates for de-weighted pixels—this can be acceptable when weights are 1 for good pixels and 0 for bad pixels that will be inpainted anyway, but can be undesirable when weights are non-binary, or when zero-weight pixels are not going to be inpainted (e.g. if some are weird rather than bad). An example approach is to generate the U matrix from the other SVD components. Choose some N_{b}×N_{b} matrix R that spans S\hat{ }, then define

U≙CV\hat{ }R. (1.3)

Then it can be proven that the span of U includes at least the span of (U\hat{ }S\hat{ }V\hat{ }), which as noted above is at least approximately the span of C—and as long as R spans S\hat{ } then this choice is independent of the exact choice of R and thus holds for a wide range of choices for R. However whereas U\hat{ } will have the weightings visible directly in the basis images, the matrix U will not. Hence U at least approximately spans C, and includes unweighted estimates of vein patterns for all pixels (including those with zero weight), even though the determination of the principle components did account for the weights (e.g. ignoring unweighted pixels). Note when W=I then U=U\hat{ }, so this approach can be considered a super-set of conventional SVD-based PCA.

There is wide latitude in choosing an R matrix a long as it spans at least the span of S\hat{ }. One very simple choice is R=I, which works fine but can lead to different basis images having different total energy which may make them harder to interpret. In some cases it can be desirable to make R similar to S\hat{ }⁻¹ so that the resulting U is orthonormal (or at least approximately so), like a conventional basis set. It is also worth noting what happens when there are zero-valued singular values. For basis i (where i≤N_{b}), if S[i]=0 then (US\hat{ })[:,i]=0, and so by manipulating (1.1), it is clear that (W_{c}CV\hat{ })[:,i] must also be zero, and from (1.3) basis i has no contribution to U for any pixels with non-zero weight. For such a basis, it is theoretically possible choose arbitrary values for R (as long as it spans S\hat{ }), since the CV\hat{ }term from the right side of (1.3) will still contain zeros. Some options for choosing R to be at least approximately orthonormal include:
1) Choosing R=S\hat{ }⁻¹ preserves the singular values and keeps WU as an orthonormal basis. But this assumes that S\hat{ } itself is invertible, which assumes that r≥N_{b}, which may not be true. Further, it may not be numerically stable if S\hat{ } contains small values, even if non-zero.
2) Choosing R=(S\hat{ }+IϵₛS\hat{ }ₘₐₓ)⁻¹ regularizes slightly to keep small diagonal elements within some orders of magnitude of the largest element. It also guarantees invertibility. This leaves R with large values, which analytically is tractable, but in practice can lead to slight numerical issues in (1.3) as this relies on CV\hat{ } being near zero for columns with small S\hat{ }.
3) Choosing R=(max{S,Iϵ\hat{ }ₛS\hat{ }ₘₐₓ})⁻¹ is similar to the previous example, but clamps the diagonals instead of adding to the diagonals. Like the previous example, it is reasonable analytically but may exhibit numerical stability issues in practice.
4) Choosing R to be diagonal with

$$R [ i ] = \{ \begin{matrix}1 / {S}^{\hat{}} [ i ] {S}^{\hat{}} [ i ] > {ϵ}_{S} {S}_{max}^{\hat{}} \\ 0 , if {S}^{\hat{}} [ i ] \leq {ϵ}_{S} {S}_{max}^{\hat{}}\end{matrix}$$

effectively discards columns with small singular values. Analytically this should lead to a similar result as 2) and 3) above, but may be more numerically stable since it doesn't rely on numerically reliable small values of CV\hat{ }.
5) R=I. This leads to each column of U having very different normalization, which is analytically reasonable, but in practice may make it harder to inspect and troubleshoot the basis images.

Recall the goal of subspace identification: that U is spans all of C, but no more than that.

All of the choices above for R lead to a U that spans all of C. However, in practice, 4) above gives a minimal, and thus commonly preferable, span of U. Hence the pseudo-inverse approach of 4) above was used to experimentally implement the methods described herein.

Note that U will be orthogonal and unit-norm if W=I and N_{b}≥r, but otherwise orthogonality or normalization are not guaranteed. The U could be re-normalized and/or re-orthogonalized, for example by running Gram-Schmidt orthogonalization. One way to implement this is by taking the QR decomposition of (CV\hat{ }), and then setting U=Q. This works but may negatively impact the subjective PCA interpretation of the bases found by the SVD. In practice, the subspace projection methods described herein do not require Uto be orthogonal or normalized (or even full rank), and so such additional orthogonalization and/or normalization steps can, in practice, be omitted. Similarly, the method below can also be used with the U obtained by other PCA variants such as RPCA or L1-SVD.

N_{b}, the number of bases, can be chosen in a variety of ways. One method is to fix N_{b} to some prescribed number a priori (e.g. 20 bases). This can lead, in practice, to several bases having zero or near-zero singular values. Since the algorithm described herein can accommodate this, this is not a reason to use another method for selecting N_{b}. Another option is similar to 4) above, where all singular values below a certain threshold are removed. Another option, which was implemented experimentally, is to do both, using an ϵₛ threshold relative to S\hat{ }ₘₐ×, and a maximum number of bases specified by a user, and the selected N_{b} value being determined as the minimum of the two.

Typically U is generated at calibration time and written to disk, then later at correction time it is retrieved and used to correct an object scan. Given an input knot tile image vector y, and a calibration basis tile matrix U, the vein estimate a can be estimated in a variety of ways. For example, begin by assuming that <U,Fx>≈0. Then <U,Fy>=<U, F(x+a)>≈<U,Fa>. In other words, suppose that the filter is designed such that the projection of the filtered true image onto the vein basis is approximately zero; then the projection of the filtered measured image onto the vein basis is approximately equal to the projection of just the filtered vein artifacts. This can be exploited to generate an estimate of the vein artifacts from the measured image, where the measured image includes the superposition of vein artifacts with a true object image.

This subspace-projection step can be analyzed in two parts: First finding b to minimize ∥WFy−WFUb∥. Then estimating the veins as a\hat{ }=Ub.

To avoid numerical problems arising with a matrix inverse, this process can be formulated as a regularized least squares problem, penalizing the norm of b to better condition the problem, so that the b doesn't exhibit numerical instability. Define a cost J as

$$J = \frac{1}{2} {‖ WFUb - WFy ‖}^{2} + \frac{{ϵ}_{J}}{2} {‖ b ‖}^{2} \qquad ( 1.6 )$$

where ϵ_{J} is some small regularization constant. By one approach, both norms are L2 norms, which exhibit sensitivity to outliers, but which also lead to a very efficient solution. the importance of outlier resistance can be reduced by choosing a W that sufficiently de-weights unreliable values. If outlier resistance is used, then a more robust norm can be used instead, for example L1 or Huber cost functionals, which can be efficiently solved with algorithms such as Chambolle & Pock's algorithm, or the Alternating Direction Method of Multipliers (ADMM). the below example provides additional implementation examples for the solution using L2 norm. Then

$$\frac{d}{db} J = ( {WFU}^{t} ( WFUb - WFy ) + {ϵ}_{J} b . \qquad ( 1.7 )$$

Setting the derivative to zero gives the solution

((WFU)^{t}(WFU)+ϵ_{J}I)b=(WFU)^{t}WFy. (1.8)

There many methods to solve this system. It can be solved directly by

b=((WFU)^{t}(WFU)+ϵⱼI)⁻¹(WFU)^{t}WFy (1.9)

which in turn can be implemented by filtering and weighting U and y and then taking dot products, e.g.

U\tilde{ }≙WFU (1.10)

y\tilde{ }≙WFy (1.11)

b=(U\tilde{ }^{t}U\tilde{ }+ϵ_{J}l)⁻¹U\tilde{ }^{t}y\tilde{ } (1.12)

where U\hat{ } is calculated by taking each frame in U and filtering and weighting it, and y\tilde{ } is calculated by filtering y then weighting it. This works in practice but can implicate the performance of separate computations to apply filtering and weighting to each scan block y. If F is fixed, then FU could be pre-computed ahead of time.

If F and W are fixed, the computational cost can be further reduced by precomputing all of (1.12) other than y\tilde{ }, which can be calculated by pre-filtering and pre-weighting an “analysis basis” G (the same size as U), whose transpose is defined as

G^{t}≙((WFU)^{t}(WFU)+ϵ_{J}I)⁻¹(WFU)^{t}WF (1.13)

This G can be pre-computed once during initialization, allowing subspace projection to be done cheaply by a single matrix multiplication,

b=G^{t}y. (1.14)

To calculate G, using the same definition for U\tilde{ } as (1.10), G^{t} is rewritten as

G^{t}=(U\tilde{ }^{t}U\tilde{ }+ϵJf)⁻¹U\tilde{ }^{t}WF.

In this form, the placement of the F on the far right side can be difficult to implement directly, since it is generally more efficient to perform filtering by direct convolution or by FFT multiplication than as an explicit matrix, and the matrix form of F may not be readily available. To make this more efficient to implement, its transpose can be found as:

G=F^{t}W^{t}U\tilde{ }(U\tilde{ }^{t}U\tilde{ }+ϵ_{J}I)⁻¹. (1.16)

G can also be further simplified. Since Wis a diagonal matrix, then W^{t}=W and so

G=F^{t}WU\tilde{ }(U\tilde{ }^{t}U\tilde{ }+ϵ_{J}I)⁻¹ (1.17)

The matrix inverse on the right is usually small (typically 20×20 or less) and computationally tractable.

If the filter F is implemented as a true matrix then the F^{t} term in (1.17) is the matrix transpose of F. If F is instead implemented as a convolution operator with some convolution kernel and some boundary conditions, then F^{t} is convolution with the mirror-image of the convolution kernel, using conjugate boundary conditions. For convolution with an even-symmetric kernel, the mirror-image kernel is the same as the unmirrored kernel, while for convolution with an odd-symmetric kernel, the mirror-image kernel is the negative of the unmirrored kernel. If convolution's boundary condition is to use zero padding, then the conjugate boundary condition is also zero padding—which can be convenient. Other boundary conditions (such as reflective, cyclic, or nearest-neighbor replication) can also be implemented but have non-trivial conjugate boundaries that can use slightly more extensive book-keeping. In some cases other boundary conditions can also be considered equivalent to zero padding, for example if weight W is zero near the borders, then WU\tilde{ } is also zero near the borders, and so convolution with other boundary conditions (such as reflective, replicative, or cyclic) can give the same result as zero boundary conditions.

For example, with an even-symmetric filter with zero padding then

G=FWU\tilde{ }(U\tilde{ }^{t}U\tilde{ }+ϵ_{J}I)⁻¹ (1.18)

The matrix-inverse term can be calculated directly, or it can be handled implicitly by using a linear systems solver to solve the following for G:

(U\tilde{ }^{t}U\tilde{ }+ϵ_{J}I)G=FWU\tilde{ } (1.19)

where F is implemented by, e.g., performing a convolution.

Note that a value for ϵ_{J} can be chosen in a variety of ways. The value should, in practice, be large enough to prevent the matrix inverse from becoming numerically unstable, but otherwise should be small enough to avoid degrading the results. One option is to let it be directly specified by a user. A more automatic approach is to set it to be several orders smaller than the norm of the matrix. This can be approximated by using the matrix trace, so we define another parameter Ep that is user-adjustable, and from that we choose

$${ϵ}_{J} = \{ \begin{matrix}{ϵ}_{p} Tr ( {U}^{\sim t} {U}^{\sim} ) , if Tr ( {U}^{\sim t} {U}^{\sim} ) > 0 \\ 1 , if Tr ( {U}^{\sim t} {U}^{\sim} ) = 0\end{matrix} \qquad ( 1.2 )$$

where the choice of 1 when trace=0 is arbitrary—any non-zero value will work and will ultimately lead to G=0. Alternatively, it could be determined that trace=0 (in examples where this is true) and G responsively set to 0 without a matrix inverse or linear solver. Once G has been pre-calculated, then for each y to be analyzed we compute:

a\hat{ }=U(Gy)=Ub (1.21)

which can be implemented as two relatively cheap matrix multiplies. Alternatively, it can be calculated using image-processing tools, where Gy can be calculated as a sum of dot products, and multiplying by U can be calculated as a weighted sum of the images from each column of U. Alternatively, for example if F or W is not fixed for all frames, then one can calculate b using (1.14) and then use a\hat{ }=Ub.

So far, the method described herein includes:

U generation once, during calibration, for a particular image sensor, using inputs C and W_{c}, and following (1.3).

If Wₚ and F are fixed, then G pre-calculated before each scan before correction, using inputs U, Wₚ, and F, and solving (1.19).

Vein estimation is performed by (1.21) in log space. It is then converted to a correction factor c\hat{ }=e^{-a\hat{ }} (or, alternatively, simply subtracted from the log of a target image prior to converting the log image data back into linear image space).

Vein correction subtracts a\hat{ } from the logged scan data. Or equivalently multiplies the unlogged scan data by c\hat{ }.

The above embodiments place minimal constraints on the choice of filter. The filter can be specified to pass frequencies that veins typically occupy, and to suppress frequencies that are typically only occupied by the scan object. Typically veins are high frequency, so the filter can have zero DC response. The Laplacian of Gaussian (LoG) filter was experimentally evaluated and observed to work well in practice. The LoG filter is even-symmetric and its border-handling can be performed by zero padding.

The pattern of weighting used to determine the calibration bases, to project a block of images into the space of the vein artifacts, and/or to use the projection of the block into the space of the veins (i.e., the vein artifact image for a particular target image) to correct a target image can be selected in a variety of ways. For example, good pixels (with trustworthy values) can be weighted with a value of 1.0 regardless of which weighting matrix is being determined, and “weird” pixels can be given zero (or small) weight, with the value of that weight, and the set of pixels classified as “weird,” optionally varying depending on which weighting matrix is being determined. Weird pixels can include (i) bad pixels, (ii) pixels with tile edge artifacts, or uncorrected artifacts other than veins, and (iii) pixels that are close enough (e.g. within one length of the filtering kernel or some other multiple of the length of the filtering kernel) to other weird (e.g., bad) pixels such that their value becomes ‘tainted’ to some degree after the filtering step.

For the experimental validation described herein, we choose:

For Calibration: (i) for all pixels marked bad in the bad pixel map, set weight to 0; (ii) for all pixels within TileEdgeArtifactWidth (e.g. 1 or 2 pixels) of physical tile edges, set weight to 0; (iii) for all other pixels, set weight to 1.

For Correction, the LoG filter used to emphasize veins used a kernel size N_{f}×N_{f}, where default is N_{f}=5 and σ_{f}=2. Let N_{d}, Nₚₑ, and N_{ce} be dilation sizes, as explained below. The bad pixel map was dilated using a morphologic kernel of size N_{d}×N_{d}. For all pixels in the dilated map (or equivalently for all pixels within N_{d} of a bad pixel in the undilated map), set weight to 0. For all pixels within Nₚₑ of the physical tile edge, set weight to 0. For all pixels within N_{ce} of the logical tile edge (i.e. the edge of the intersection of the physical tile with the image bounding box), set weight to 0. For all other pixels, set weight to 1.

Physical and logical tile regions were differentiated to account for the possibility that some tiles may have been cropped before being operated on by the algorithms described herein.

When choosing weights, there is a tradeoff in quality vs. quantity. As a non-limiting illustrative examples, the weighting scheme for a square filter of size N_{f}×N_{f}, is detailed below, though the approach can also be used for non-square filters by repeating the following approach for each dimension. A conservative approach is to give zero weight to any pixel that isn't fully trustworthy. Specifically, for correction, to completely eliminate the effect of any weird pixels on the correction of non-weird pixels, one can choose N_{d}=N_{ce}=2N_{f}−1, where N_{f} is the filter size, and Nₚₑ=N_{d}+TileEdgeArtifactWidth. The factor of two comes about because F appears twice in the solution (e.g. this appears explicit in (1.9) and (1.13), but also implicitly in (1.19) and similar, since there is an F inside of U\tilde{ }), so the reach of each weird pixel is twice the filter length (aside from the center pixel). This assures that all data used in the subspace projection is completely trustworthy, but can lead to a lot of the available image data being discarded, which can lead to a noisier fit. N_{d} is chosen so the filter doesn't reach any bad pixels, N_{ce} is chosen so the filter doesn't use pixels outside the tile, and Nₚₑ is chosen so the filter doesn't use pixels that may exhibit tile edge artifacts.

In many cases this conservative approach works well, but the downside is it can de-weight a lot of available data, and in some cases this can lead to poor statistics. Alternatively, a less conservative method could be formulated to allow some values to be used even if their pixels are not completely trustworthy. This can be beneficial in a variety of circumstances, e.g., in the case where bad pixels have already been inpainted. One choice, for example, is N_{d}=N_{ce}=N_{f}, and Nₚₑ=N_{d}+TileEdgeArtifactWidth. Other weightings are also possible, such as first setting weights to 0 within a dilation of the filter size N_{f} and then dilating again but gradually feathering up to weight=1 over the range of that second dilation, instead of a standard Boolean dilation. This can be done by implementing the second dilation as a linear convolution with a flat kernel, yielding linear feathering. Additionally or alternatively, a convolution approach could be used so that the weighting falls off in a way that reflects the shape of F (such as convolving with the magnitude or magnitude-squared of the coefficients in F). For some choices of boundary conditions for F, it may also be reasonable to reduce N_{ce} or set it to zero.

Any errors in the DC component of the correction can translate to tile-level noise which, if severe enough, can lead to a checkerboard artifact over the entire image. There are a number of approaches to addressing the DC term, and the choice depends on the underlying artifact mechanism(s), the other processing involved, and the speed-vs-accuracy goal. By one approach, further downstream processing can equalize the tile DC terms, and so the correction methods described herein can ignore the question of DC accuracy.

Consider the DC effect of such a correction. If F has zero DC response (e.g. as with the LoG filter), then G must have zero (or close to it) DC component, and so Gy is (mostly) independent of the DC value of y. This will be true regardless of the DC value of U. Yet the DC value of U will still be scaled and added to the vein estimate, so allowing Uto have a random DC value will likely lead to the introduction of a checkerboard artifact across the tiles of an image. There are a number of ways to combat this, including, separately for each tile:
1) The mean or weighted mean (weighted by W) of each image of U (or equivalently of each column of the U matrix) could be subtracted after the SVD. The unweighted mean can be contaminated by bad pixels, so weighted can instead be used. However, if the bases are eventually forced to zero-DC anyway, then subtracting the mean before the SVD may be advantageous so SVD can focus on capturing artifact variation without also trying to capture an unwanted DC variation.
2) The weighted mean of each input calibration frame can be subtracted prior to the SVD. In other words, for each column in C, the weighted mean (weighted by W) can be calculated and subtracted from C prior to the SVD. This approach ensures that U will be zero mean (or nearly so). It is appropriate for physical mechanisms whose effect in log (or other nonlinear) space has zero mean. It can also be beneficial for mechanisms where the effect in unlogged space has zero mean and is relatively small (per Taylor's theorem). It is also fast and straightforward, so it is also a reasonable choice when an additional, separate per-tile DC correction algorithm will also be run on the output of this algorithm, so that this algorithm can operate less aggressively.
3) Like (2), but instead of a weighted mean to estimate DC value, the median could be determined (e.g., taking median of each frame of each tile of C over only the pixels for which W=1).
4) U could retain a carefully adjusted DC term, for example like (2) but instead of subtracting the weighted mean of each image, subtracting the weighted mean across related images, e.g. all images acquired with the same nominal tube current. This can be advantageous when there is temporal variation in DC levels that is correlated with the temporal variation in high frequency artifacts. In particular when paired with a filter with zero DC response, this approach can allow the algorithm to estimate the DC variation even though the DC is suppressed in the subspace projection (so the DC artifact estimation is independent on the object's DC level).
5) U could retain its entire original DC term.
6) One could use a filter with non-zero DC response.
7) One could re-scale the corrected image to preserve the total signal value in the tile, or the weighted total signal value (to ignore bad values). That is, first calculate the mean of the unlogged input tile image, then multiply by scaling factor (c\hat{ }=e^{-a\hat{ }}), then calculate the mean of the corrected tile image, and subtract the difference so that the corrected image has the same mean as the input. This can be appropriate, for example, for a vein artifact model where the effective pixel boundaries shift over time, so photons aren't gained or lost, but merely diverted between neighboring pixels. However, this approach can be computationally intensive if applied to every corrected image.
8) One could adjust the correction term so that, when applied to the unlogged input knot image, the total signal value (or weighted signal value) in the unlogged knot image is preserved. That is, find the correction image c\hat{ }=e^{-a\hat{ }}, and scale it by (sum W y)/(sum W y c\hat{ }), then use that scaled correction image to correct the object images. This is very similar to (7), and is appropriate for the same types of use cases, but it works on the knot images rather than the images, and so can be much more computationally attractive.
9) One could adjust the correction term to have unity harmonic mean. That is, find the correction image c\hat{ }=e^{-a\hat{ }}, and scale it by (sum W)/(sum W c\hat{ }), then use that scaled correction image to correct the object images. This is similar to (8) but with the y terms removed, or equivalently if one were to assume that y were a flat field. This is less computationally demanding than (8) or (7), but more computationally intensive than other options like (2). This choice can be appropriate for the same types of use cases as (7) or (8) but where a faster algorithm is desired, or where it is desired to avoid letting the DC re-scaling factor be affected by the pixel values (e.g. if there might be undetected pixel defects that didn't get marked as bad). It can also be appropriate for certain artifact mechanisms or assumptions, for example if effective pixel boundaries are moving but there are effects such as charge sharing, or a dead zone near pixel boundaries, so total signal count isn't exactly preserved.

In the example above, the image data was single-channel (e.g., a single channel of photon counts across a single band of photon energies). Many image sensors provide multiple channels of image data, e.g., counts for photons received by each pixel of the sensor in respective different photon energy bands. E.g., a detector pixel could have N_{ch} channels (a.k.a. energy bins). Several approaches are possible to adapt the methods described herein to such a multi-channel scenario. In some multi-channel implementations, bad-pixel maps may be channel-dependent, so it is possible to mark different channels good or bad within a single pixel, or may be channel-independent, where each pixel is marked good or bad across all channels within that pixel. All approaches discussed herein support channel-independent bad pixel maps, though most approaches also support channel-dependent bad pixel maps. Similarly, all approaches discussed herein support channel-independent weightings, though most approaches also support channel-dependent weightings When applying a filter (such as a LoG filter), one can either apply the same 2D filter to all channels, or one may use a different 2D filter for each channel, or one can use a 3D filter that works across channels. All approaches discussed herein support channel-independent 2D filters, most support channel-dependent 2D filters, and some support 3D filters.

Some multi-channel calibration approaches include (for each tile):
1) An “independent” calibration approach, where the single-channel calibration algorithm(s) described herein are performed separately for each channel's data. This yields a stack of calibration basis images for each channel, or equivalently the images may be re-arranged into a single stack of multi-channel calibration basis images. This approach can be appropriate, for example, when the artifacts in different channels are uncorrelated or have highly non-linear interactions.
2) A “tightly coupled” calibration approach, where all the channels of an image are ‘unrolled’ (for example by concatenating all the image planes vertically or horizontally) to obtain a bigger image that can be treated as single image channel. In such an example, the C matrices for each channel can be concatenated vertically to get a “tall” C matrix, with the weights similarly concatenated or replicated. The SVD, PCA, or other basis-generating method is then performed on the tall C matrix to obtain a tall U matrix, which itself can be interpreted as the vertical concatenation of the U matrices for each channel. The tall U matrix can be treated as a stack of multi-channel basis images, or equivalently it can be rearranged into a separate stack of basis images for each channel. This approach can be appropriate, for example, when the artifacts in one channel and the artifacts in another channel have a well-behaved linear (or nearly linear) relationship, such that measuring the artifact in one channel can help to predict the artifact in another channel.
3) A “loosely coupled” calibration approach. In this approach each channel is treated as a separate image frame going into the PCA, SVD, or other basis-generating technique. That is, we take the C matrices for each channel and concatenate them horizontally to get a “wide” C matrix, then perform the SVD or PCA on the wide C matrix. The resulting U matrix is functionally single-channel and can later be used to correct all channels. This approach can be appropriate, for example, when the artifacts in different channels all exist within substantially the same subspace, but in any single image the exhibited artifact in one channel is not well correlated with the exhibited artifact in another channel.
4) A “master channel” calibration approach, where a particular channel is chosen as the master channel (typically this would be the channel with the best statistics, for example the full-energy channel when using photon counting with cumulative energy bins. The single-channel calibration algorithm is run on just that one channel. The resulting single-channel bases are then used to correct all channels. This approach can be appropriate, for example, when artifacts are correlated (like in Tightly Coupled or Loosely Coupled) but where some channels are so noisy that it is beneficial to use the information from a different channel to calibrate and/or correct them.

Note that some of these calibration approaches result in the production of multi-channel calibration basis images (e.g. for Independent or Tightly Coupled), while some produce single-channel calibration basis images (e.g. for Master Channel or Loosely Coupled). Either style may be used to correct multi-channel images. When correcting a target channel in a multi-channel image using a multi-channel basis, the “corresponding channel basis” refers to the corresponding channel plane from the multi-channel basis. When correcting a target channel in a multi-channel image using a single-channel basis, the “corresponding channel basis” refers to the single-channel basis.

Given some set of calibration basis images, some correction approaches include (for each tile):
1) An “independent” correction approach, where each channel is projected independently onto the corresponding channel basis. That is, apply (1.12) or (1.14) independently for each channel, obtaining a separate b vector for each channel, and hence also a separate artifact estimate a\hat{ }=Ub for each channel.
2) A “tightly coupled” correction approach, where all channels are unrolled within the image, and the “tall” block image y is projected onto the “tall” multi-channel basis U (optionally using a tall G), then (1.12) or (1.14) yields a single b vector that if applicable to all channels, and then a\hat{ }=Ub yields the multi-channel artifact estimate. This correction approach is most appropriate with tightly coupled calibration, though could technically be used for other calibration approaches—if calibration images were produced on a single-channel basis, it can be replicated across channels, or equivalently U can be replicated vertically to produce the tall U matrix.
3) A “master channel” correction approach, where only the master channel (typically the full-energy channel) is projected onto its corresponding channel, e.g. using (1.12) or (1.14), to obtain a vector b that is shared by all channels. Then a\hat{ }=Ub is calculated separately for each channel, where U is the corresponding channel basis, to yield different artifact patterns for each channel.

For all three of these correction approaches, the artifact estimates a\hat{ } can be assembled into a multi-channel knot correction image to be subtracted from the log object images, or equivalently the gain correction terms c\hat{ } can be assembled into to a multi-channel correction image to multiply the unlogged object images.

Various combinations of these calibration and correction approaches can be used. For example, independent calibration and independent correction can be used together when the artifacts are not well correlated across channels. Tightly coupled calibration and correction can be used together when artifacts are tightly coupled or linearly dependent across channels. Master channel calibration and correction can be used together when artifacts are tightly correlated or linearly dependent across channels but one channel is much less noisy than the others. Loosely coupled calibration and independent correction can be used together when artifacts for different channels share the same subspace but have different realizations. And other combinations can also be used as appropriate. Sensor measurements can also optionally be included in the algorithm(s) described herein, e.g., to augment image-based artifact estimation methods. For example (per tile), a temperature measurement, or an array of temperature measurements at different spatial locations, detector supply voltage measurement(s), detector supply current measurement(s), X-ray source voltage measurement, X-ray source current measurement, a norm chamber measurement, and/or other sensor measurement(s) of physical variables that are predictive (e.g., that are causative) of vein or other artifacts as described herein could be measured. Such measurements can optionally be included in the above approaches by treating them as additional ‘pixels,’ e.g., by appending them as additional rows in C (in calibration), y (in correction), and W (in calibration and correction), noting that they will also appear in related matrices such as U and G. If a measurement is correlated with the artifacts, and the measurement is appended to C, then PCA (or other basis generation technique) will uncover that correlation and so the calibration bases will include that measurement's contribution to each artifact basis pattern. Similarly, by appending the sensor measurement to y, the subspace projection space will take those correlations into account when estimating the bias pattern. Any differences in scale between the measurements and the pixel values can be addressed by incorporating that scale into the W vectors.

The algorithm can also be extended to account for various nonlinearities, by including image perturbations. Perturbations can be generated, example.g., with simple nonlinear transforms. For example, instead of using only the logarithm of the data, we can also use the unlogged data, the square root of unlogged data, the square of unlogged data, the square of the unlogged data, and/or other polynomial powers, etc., each of which can be used to produce additional image sets. As another example, perturbed image sets can be generated by adding, removing (or suppressing), or modifying various corrections. For example, by making image sets with and without pulse pileup correction, or by applying multiple different pulse pileup correction algorithms to the same data set. In one approach, various perturbations can be combined in the frame direction, so that their C matrices are concatenated horizontally before running the PCA, SVD, or other basis generation technique(s) (similar to the loosely correlated multi-channel calibration approach), then correction performed as usual (without perturbations). By another approach, perturbations can be combined in the pixel direction, so their C matrices are concatenated vertically before the PCA, SVD, or other basis generation technique(s) (similar to the Tightly Coupled multi-channel calibration), and their y matrices are concatenated vertically before applying (1.12) or (1.14) (similar to Tightly Coupled correction), but then a\hat{ }=Ub is calculated only for the portion of U corresponding to the unperturbed section of y. The former (treating perturbations as frames) can enlarge the artifact subspace produced by calibration, which can be useful e.g. when artifacts are fairly linear but it is not practical to capture the entire subspace in one set of calibration scans. The latter (treating perturbations as pixels) can be useful e.g. when there is a nonlinear relationship between the artifacts and the incoming pixel values.

### III. Example Systems

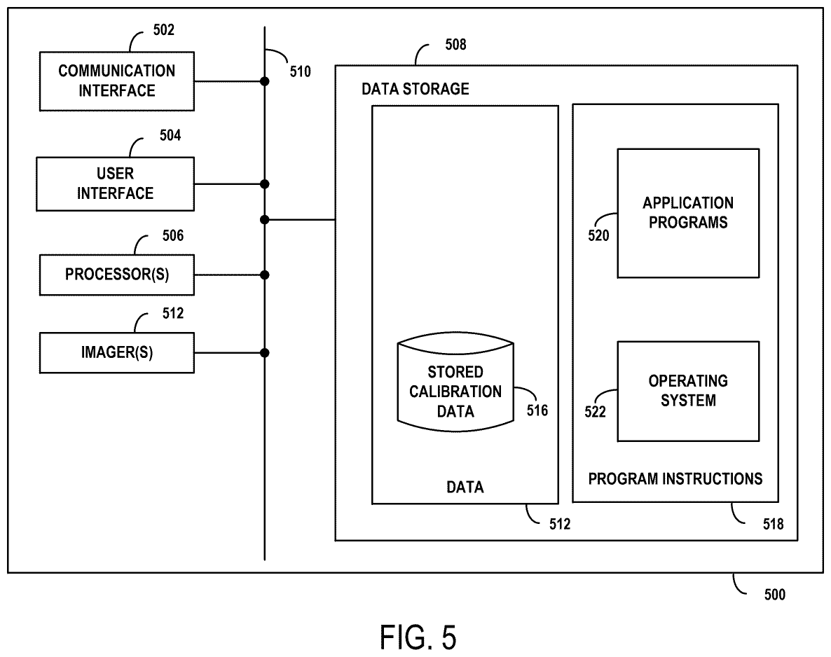

FIG. 5 illustrates an example system 500 that may be used to implement the methods described herein. By way of example and without limitation, system 500 may be or include a computer (such as a desktop, notebook, tablet, or handheld computer, a server), elements of a medical or otherwise configured imagine system (e.g., a 2-D or 3-D X-ray or other imaging system that includes photon-counting image sensors using cadmium telluride photon-sensitive pixels or other photon-detecting materials or elements), or some other type of device or system or combination of devices and/or systems. It should be understood that elements of system 500 may represent a physical instrument and/or computing device such as a server, a particular physical hardware platform on which applications operate in software, all or a portion of a cloud computing environment or other system configured to provide computational resources to many users and/or for many applications or programs, or other combinations of hardware and software that are configured to carry out functions as described herein.

As shown in FIG. 5, system 500 may include a communication interface 502, a user interface 504, one or more processors 506, one or more imager(s) 512, and data storage 508, all of which may be communicatively linked together by a system bus, network, or other connection mechanism 510.

Communication interface 502 may function to allow system 500 to communicate, using analog or digital modulation of electric, magnetic, electromagnetic, optical, or other signals, with other devices (e.g., with systems that provide x-ray or other images or sets of images of a subject, with systems that generate or store calibration images or other calibration data for one or more tiles or other elements of the imager(s) 512), access networks, and/or transport networks. Thus, communication interface 502 may facilitate circuit-switched and/or packet-switched communication, such as Internet protocol (IP) or other packetized communication. For instance, communication interface 502 may include a chipset and antenna arranged for wireless communication with a radio access network or an access point. Also, communication interface 502 may take the form of or include a wireline interface, such as an Ethernet, Universal Serial Bus (USB), or High-Definition Multimedia Interface (HDMI) port. Communication interface 502 may also take the form of or include a wireless interface, such as a WiFi, BLUETOOTH®, global positioning system (GPS), or wide-area wireless interface (e.g., WiMAX, 3GPP Long-Term Evolution (LTE), or 3GPP 5G). However, other forms of physical layer interfaces and other types of standard or proprietary communication protocols may be used over communication interface 502. Furthermore, communication interface 502 may comprise multiple physical communication interfaces (e.g., a WiFi interface, a BLUETOOTH® interface, and a wide-area wireless interface).

User interface 504 may function to allow system 500 to interact with a user, for example to receive input from and/or to provide output to the user. Thus, user interface 504 may include input components such as a keypad, keyboard, touch-sensitive or presence-sensitive panel, computer mouse, trackball, joystick, microphone, and so on. User interface 504 may also include one or more output components such as a display screen which, for example, may be combined with a presence-sensitive panel. The display screen may be based on CRT, LCD, and/or LED technologies, or other technologies now known or later developed. User interface 504 may also be configured to generate audible output(s), via a speaker, speaker jack, audio output port, audio output device, earphones, and/or other similar devices. The user interface 504 may be operable to permit a user to initiate a calibration procedure, to provide inputs related thereto (e.g., a desired number of basis calibration images to retain for use in correcting future images generated using the imager(s) 512), and/or to receive feedback related thereto (e.g., to display determined calibration bases/images to indicate whether stimulation provided by the system provoked a haptic perception on the lip, to indicate that the lip is being contacted by a tongue or opposite lip). The user interface 504 may be operable to permit a user to initiate imaging of an object (e.g., a body part of a patient) and to use previously stored calibration images to correct images generated thereby so as to reduce or remove vein artifacts therein.

Processor(s) 506 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). Data storage 508 may include one or more volatile and/or non-volatile storage components, such as magnetic, optical, flash, or organic storage, and may be integrated in whole or in part with processor(s) 506 and/or with some other element of the system. Data storage 508 may include removable and/or non-removable components.

Processor(s) 506 may be capable of executing program instructions 518 (e.g., compiled or non-compiled program logic and/or machine code) stored in data storage 508 to carry out the various functions described herein. Therefore, data storage 508 may include a non-transitory computer-readable medium, having stored thereon program instructions that, upon execution by system 500, cause system 500 to carry out any of the methods, processes, or functions disclosed in this specification and/or the accompanying drawings. The execution of program instructions 518 by processor(s) 506 may result in processor 506 using data 512.

By way of example, program instructions 518 may include an operating system 522 (e.g., an operating system kernel, device driver(s), and/or other modules) and one or more application programs 520 (e.g., functions for executing the methods described herein) installed on system 500. Data 512 may include stored calibration data 516 (e.g., stored sets of calibration images that represent the range of possible behaviors of veins within teils or other image sensor elements of the imager(s) 512) that can be used to reduce or remove vein artifacts in image data generated using the imager(s) 512. For example, the calibrator may generate calibration basis images (or equivalently U matrices) which are stored for later retrieval to be used for image correction; or it may optionally also store W, G, C, and/or other related images, matrices, vectors, or arrays.

Application programs 520 may communicate with operating system 522 through one or more application programming interfaces (APIs). These APIs may facilitate, for instance, application programs 520 transmitting or receiving information via communication interface 502, receiving and/or displaying information on user interface 504, and so on.

Application programs 520 may take the form of “apps” that could be downloadable to system 500 through one or more online application stores or application markets (via, e.g., the communication interface 502). However, application programs can also be installed on system 500 in other ways, such as via a web browser or through a physical interface (e.g., a USB port) of the system 500. Application programs could also be pre-installed in a hardware platform, such as in a detector package.

### IV. Example Methods

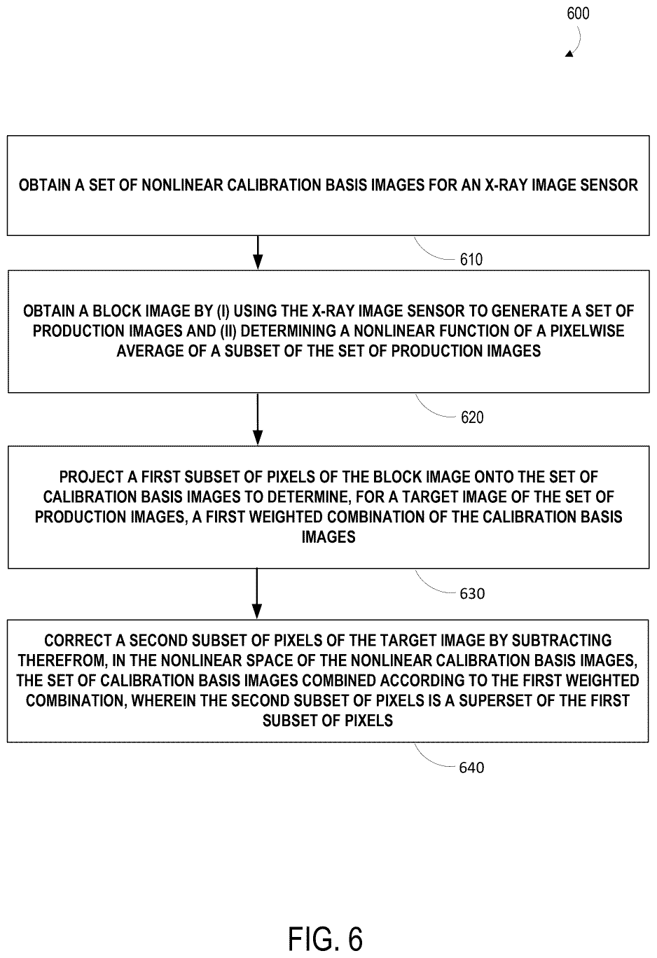

FIG. 6 depicts an example method 600. The method 600 includes obtaining a set of nonlinear calibration basis images for an X-ray image sensor (610). The method 600 additionally includes obtaining a block image by (i) using the X-ray image sensor to generate a set of production images and (ii) determining a nonlinear function of a pixelwise average of a subset of the set of production images (620). The method 600 yet further includes projecting a first subset of pixels of the block image onto the set of calibration basis images to determine, for a target image of the set of production images, a first weighted combination of the calibration basis images (630). The method 600 also includes correcting a second subset of pixels of the target image by subtracting therefrom, in the nonlinear space of the nonlinear calibration images, the set of calibration basis images combined according to the first weighted combination, wherein the second subset of pixels is a superset of the first subset of pixels (640). The method 600 could include additional steps or features.

### V. Conclusion

It should be understood that arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

What is claimed is:

1. A method comprising:
obtaining a set of nonlinear calibration basis images for an X-ray image sensor;
obtaining a block image by:
using the X-ray image sensor to generate a set of production images; and
determining a nonlinear function of a pixelwise average of a subset of the set of production images;
projecting a first subset of pixels of the block image onto the set of nonlinear calibration basis images to determine, for a target image of the set of production images, a first weighted combination of the set of nonlinear calibration basis images; and
correcting a second subset of pixels of the target image by subtracting therefrom, in a nonlinear space of the nonlinear calibration basis images, the set of nonlinear calibration basis images combined according to the first weighted combination, wherein the second subset of pixels is a superset of the first subset of pixels.

2. The method of claim 1, wherein correcting the second subset of pixels of the target image comprises:
determining, from the set of nonlinear calibration basis images combined according to the first weighted combination, a set of scaling factors; and
scaling the second subset of pixels of the target image according to the scaling factors.

3. The method of claim 1, further comprising applying, to the set of production images prior to determining the nonlinear function of the pixelwise average of the subset of the set of production images, at least one of a pulse pile-up artifact correction or a bad pixel artifact correction.

4. The method of claim 1, wherein projecting the first subset of pixels of the block image onto the set of nonlinear calibration basis images comprises projecting a version of the first subset of pixels of the block image that has been filtered to enhance artifacts therein by applying an artifact filter thereto.

5. The method of claim 4, wherein projecting the first subset of pixels of the block image onto the set of nonlinear calibration basis images comprises:
determining, based on the set of nonlinear calibration basis images and the artifact filter, a projection matrix; and
multiplying the projection matrix and the block image to generate a set of weights for the first weighted combination.

6. The method of claim 1, wherein:
projecting the first subset of pixels of the block image onto the set of nonlinear calibration basis images comprises projecting a product of the block image and a projection weighting matrix onto the set of nonlinear calibration basis images; and
elements of the projection weighting matrix that correspond to pixels of the X-ray image sensor that are not members of the first subset of pixels have weightings of zero.

7. The method of claim 1, wherein the first subset of pixels excludes:
a set of bad pixels of the X-ray image sensor;
a set of pixels of the X-ray image sensor within a specified distance from the bad pixels of the X-ray image sensor; or
a set of pixels of the X-ray image sensor within a specified distance of an edge of the X-ray image sensor.

8. The method of claim 1, further comprising:
using the X-ray image sensor to generate a set of calibration source images; and
determining the set of nonlinear calibration basis images based on nonlinear versions of the set of calibration source images.

9. The method of claim 8, wherein:
determining the set of nonlinear calibration basis images based on the nonlinear versions of the set of calibration source images comprises determining the set of nonlinear calibration basis images based on a third subset of pixels of the nonlinear versions of the set of calibration source images; and
the third subset of pixels is a superset of the first subset of pixels.

10. The method of claim 9, wherein the third subset does not include:
a set of bad pixels of the X-ray image sensor; or
a set of pixels of the X-ray image sensor within a specified distance of an edge of the X-ray image sensor.

11. The method of claim 8, wherein determining the set of nonlinear calibration basis images based on the nonlinear versions of the set of calibration source images comprises:
performing a singular value decomposition or principal components analysis on the nonlinear versions of the set of calibration source images to generate a source set of calibration basis images; and
selecting a subset of the source set of calibration basis images as the set of nonlinear calibration basis images.

12. The method of claim 1, further comprising:
obtaining a second block image by determining a second nonlinear function of a second pixelwise average of a second subset of the set of production images; and
projecting the first subset of pixels of the second block image onto the set of nonlinear calibration basis images to determine a second weighted combination of the set of nonlinear calibration basis images, wherein correcting the second subset of pixels of the target image comprises:
interpolating the first weighted combination and the second weighted combination to generate, for the target image, a third weighted combination of the calibration basis images; and
correcting the second subset of pixels of the target image by subtracting therefrom, in the nonlinear space of the nonlinear calibration images, the set of calibration basis images combined according to the third weighted combination.

13. The method of claim 1, wherein:
the set of nonlinear calibration basis images are logarithmic calibration basis images; and
the nonlinear function is a logarithm.

14. The method of claim 1, wherein the method is performed in a tile-wise manner for each tile of a plurality of tiles of the X-ray image sensor.

15. The method of claim 14, further comprising performing a DC correction in a tile-wise manner such that checkerboard artifacts in a corrected target image are reduced.

16. The method of claim 1, further comprising obtaining, by a sensor, a measurement of a physical variable of the X-ray image sensor, wherein projecting the first subset of pixels of the block image onto the set of nonlinear calibration basis images to determine the first weighted combination of the set of nonlinear calibration basis images comprises projecting the first subset of pixels of the block image and the measurement onto the set of nonlinear calibration basis images to determine the first weighted combination of the set of nonlinear calibration basis images.

17. The method of claim 1, wherein:
the set of production images comprises multiple channels of image information; and
correcting the second subset of pixels of the target image comprises correcting multiple channels of the target image.

18. The method of claim 1, wherein projecting the first subset of pixels of the block image onto the set of nonlinear calibration basis images comprises projecting the first subset of pixels of the block image onto the set of nonlinear calibration basis images in a manner that reduces an L1 loss function of the projection of the first subset of pixels of the block image onto the set of nonlinear calibration basis images.

19. A non-transitory computer-readable medium having stored therein instructions executable by a processor to cause the processor to perform a method comprising:
obtaining a set of nonlinear calibration basis images for an X-ray image sensor;
obtaining a block image by:
using the X-ray image sensor to generate a set of production images; and
determining a nonlinear function of a pixelwise average of a subset of the set of production images;
projecting a first subset of pixels of the block image onto the set of nonlinear calibration basis images to determine, for a target image of the set of production images, a first weighted combination of the set of nonlinear calibration basis images; and
correcting a second subset of pixels of the target image by subtracting therefrom, in a nonlinear space of the nonlinear calibration basis images, the set of nonlinear calibration basis images combined according to the first weighted combination, wherein the second subset of pixels is a superset of the first subset of pixels.

20. A system comprising:
at least one processor; and
a non-transitory computer-readable medium, having stored therein instructions executable by the at least one processor to cause the system to perform a method comprising:
obtaining a set of nonlinear calibration basis images for an X-ray image sensor;
obtaining a block image by:
using the X-ray image sensor to generate a set of production images; and
determining a nonlinear function of a pixelwise average of a subset of the set of production images;
projecting a first subset of pixels of the block image onto the set of nonlinear calibration basis images to determine, for a target image of the set of production images, a first weighted combination of the set of nonlinear calibration basis images; and
correcting a second subset of pixels of the target image by subtracting therefrom, in a nonlinear space of the nonlinear calibration basis images, the set of nonlinear calibration basis images combined according to the first weighted combination, wherein the second subset of pixels is a superset of the first subset of pixels.
